(19) United States
(12) Patent Application Publication
(10) Pub. No.: US 2011/0307776 A1
(43) Pub. Date: Dec. 15, 2011

(54) TRANSCODING A WEB PAGE

(75) Inventor: Ronan Cremin, Dublin (IE)

(73) Assignee: MTLD TOP LEVEL DOMAIN LIMITED, Dublin (IE)

(21) Appl. No.: 13/123,378

(22) PCT Filed: Oct. 9, 2009
(86) PCT No.: PCT/GB2009/002420

§ 371 Date: Aug. 30, 2011

(30) Foreign Application Priority Data
Oct. 10, 2008 (GB) 0818639.7

(51) Int. Cl. G06F 17/00

(52) U.S. Cl. 715/235

(57) ABSTRACT

A transcoding system (1) comprises a mobile communication device (2) that connects to the internet (4) via a mobile communication network (3). When the mobile communication device (2) requests a web page of a web site stored at a web server (5), the request is routed to a transcoder (6). The transcoder (6) retrieves the web page from the web server (5). It then transcodes the web page and provides the transcoded web page to the mobile communication device (2). The transcoder (6) pre-crawls the web site to extract information found on the web site. When transcoding the web page, the transcoder (6) generates elements for insertion into the transcoded web page based on the information extracted during the pre-crawl of the web site.

### FIELD OF THE INVENTION

This invention relates to transcoding a web page of a web site. The invention has particular, but not exclusive, application to transcoding the web page for use by a mobile communication device.

### BACKGROUND TO THE INVENTION

Most web sites are intended for use by desktop and laptop personal computers (PCs). Web pages of such web sites are often unsuitable for use by mobile communication devices. They may include script, graphics, images, animations, video data, audio data, layouts etc. that are not supported by a mobile communication device. For example, a web page may include Java® or Adobe® Flash script, but a mobile communication device may not have the correct software to use the script. Similarly, an image on a web page may be too large to be displayed on a mobile communication device.

In light of this, web pages of web sites intended for use by PCs are often transcoded such that they are suitable for use by mobile communication devices. For example, when the user of a mobile communication device requests a given web page via a mobile communication network, instead of the mobile communication device being provided with the web page itself, it is provided with a transcoded version of the web page.

Typically, the transcoding involves identifying the type of mobile communication device that made the request and adapting the web page to be suitable for that device. For example, if the web page is encoded using script that is not supported by the type of mobile communication device, the web page may be converted to script that is supported by the type of mobile communication device. Similarly, an image included in the web page may be resized to suit the limitations of the display of the mobile communication device.

It is possible to transcode web pages of a web site intended for use by PCs privately and then publish the results on a web server that can be accessed by mobile communication devices via a mobile communication network and the internet. Transcoding software is available for this purpose. However, web pages transcoded in this way are generally static. The transcoded web pages are not actively adapted in response to the type of mobile communication device accessing the web site. Rather, the transcoded web site is made suitable for a large range of types of mobile communication device and every device that requests a web page of the web site is provided with the same transcoded version of the web page. This significantly limits user experience of the web site, as the transcoded web pages must be encoded to be suitable for use by types of mobile communication devices with the most limited capabilities.

For this reason, transcoding software is often implemented to operate “on the fly”. A computer that transcodes web pages on the fly can conveniently be referred to as a transcoder. When the transcoder receives a request for a web page from a mobile communication device, it identifies the type of mobile communication device making the request and provides a transcoded version of the web page adapted to be suitable for that type of mobile communication device. In some instances, each time a request for a web page of a web site intended for use by PCs is received, the transcoder may retrieve the web page for transcoding from the web server on which the web page is stored. In other instances, the transcoder may cache web pages locally, ready for transcoding when a request for one of the cached web pages is received. In either instance, the web page is only transcoded when a request for it is received, as only at that stage can the type of mobile communication device making the request be identified. Transcoding web pages on the fly can therefore slow down the speed with which web pages are provided to mobile communication devices.

The speed of internet browsing on mobile communication devices is in any event a concern, due to the inevitably limited capacity of mobile communication networks to transmit data to mobile communication devices. User experience of such internet browsing is not always therefore positive. In particular, whilst it is fairly straightforward to browse different pages of a web site on a PC with a fast connection to the internet in order to find information on a web site, such browsing on a mobile communication device is generally much slower and it can therefore be more difficult to find information on a web site using a mobile communication device.

The present invention seeks to overcome these problems.

### SUMMARY OF THE INVENTION

According to a first aspect of the present invention, there is provided a method of providing a transcoded page of a web site, the method comprising:

parsing a plurality of web pages of the web site to extract information found on the web site;

storing the extracted information;

receiving a request for the web page;

transcoding the web page; and

providing the transcoded web page in response to the request,

wherein transcoding the web page includes generating an element representing the stored information and inserting the element into the transcoded web page.

Also, according to a second aspect of the present invention there is provided apparatus for providing a transcoded page of a web site, the apparatus comprising a transcoder for:

parsing a plurality of web pages of the web site to extract information found on the web site;

storing the extracted information;

receiving a request for the web page;

transcoding the web page; and

providing the transcoded web page in response to the request,

wherein transcoding the web page includes generating an element representing the stored information and inserting the element into the transcoded web page.

So, the web page can effectively be partially transcoded in advance by parsing the web site to find information that may be useful during subsequent transcoding. Typically, the parsing is therefore performed in advance of the transcoding.

By parsing a plurality of web pages of the web site, information from other pages of the web site or even the entire web site can be used when transcoding the requested web page. This allows information not found on the requested web page to be provided in the transcoded web page. The promotion of important information onto the transcoded web page can significantly improve user experience when browsing the web site on a mobile communication device, as important information can be found much more quickly.

In one example, the information that may be extracted by parsing the plurality of web pages of the web site and then stored is a street address found on the web site. Alternatively, the information may be a telephone number found on the web site. It is important to consider street address and telephone number information may not be present on the front page, home page or index page of a web site, which pages are usually first requested. Often, a separate contact details page is provided on a web site. However, a user of a mobile communication device is very likely to be looking at a web site to establish address information, for example to find the location or telephone number of a business that owns the web site. Inserting an element representing street address or telephone number information into a transcoded web page based on a web page that does not contain a street address or telephone number can therefore be particularly useful to users of mobile communication devices.

The element may enhance the information it represents. For example, the element may be a map including an icon representing the location of a street address found on the website. Preferably, the location (and hence the icon) is substantially at the centre of the map. Similarly, the element may be a link related to the telephone number, the selection of which link initiates dialing of the telephone number. This can improve user experience of the website, by providing the information in a convenient and more readily usable format.

In another example, the element represents a brand logo found on the website. Businesses often place a great deal of importance on promoting their brand and having it presented in a consistent way. Users also find brands useful for quickly identifying businesses. By inserting an element representing a brand logo into a transcoded web page, consistency of presentation can be achieved.

The element can be inserted at any position in the transcoded web page. However, it can be particularly useful for it to be inserted at the top of the transcoded web page. This allows promotion of the information represented by the element. So, transcoding the web page may include inserting the generated element at the top of the transcoded web page.

In another example, the element may provide search engine optimization for the transcoded version of the web site. Generating the element may comprise converting street address information found on the website to machine-readable geographic data. Hence the element may comprise the machine-readable geographic data. Search engines that allow geographical searching or automatically place icons on maps to represent locations associated with web sites can therefore gather geographical information from the transcoded web page more accurately.

The method and apparatus are not limited to inserting just one element into the transcoded web page. Rather, the method may comprise parsing the plurality of web pages of the web site to extract further information found on the web site; and

storing the further information;

wherein transcoding the web page includes generating a further element representing the stored further information and inserting the further element into the transcoded web page.

Likewise, the transcoder of the apparatus may parse the plurality of web pages of the web site to extract further information found on the web site; and

store the further information;

wherein transcoding the web page includes generating a further element representing the stored further information and inserting the further element into the transcoded web page.

The element and further element may be any two of the elements set out in the examples discussed herein. In other examples, yet further information may be extracted and yet further elements representing that information may be generated and inserted into the transcoded web page. Indeed, there is no specific limit to the information that may be extracted and the number of elements that may be generated and inserted.

As outlined above, whilst not limited to providing the transcoded web page to any particular type of device, the method and apparatus are particularly useful for providing the transcoded web page to a mobile communication device.

Advantageously, the country to which the information found on the web site most likely relates can be identified and the information may be extracted using one or more rules associated with the identified country. The information may also be verified, typically during extraction and/or before it is stored.

Use of the words “apparatus”, “transcoder” and so on are intended to be general rather than specific. Whilst these features of the invention may be implemented using an individual component, such as a computer or a central processing unit (CPU), they can equally well be implemented using other suitable components or a combination of components. For example, the invention could be implemented using a hard-wired circuit or circuits, e.g. an integrated circuit, or using embedded software. It can also be appreciated that the invention can be implemented, at least in part, using computer program code. According to another aspect of the present invention, there is therefore provided computer software or computer program code adapted to carry out the method described above when processed by a computer processing means. The computer software or computer program code can be carried by computer readable medium. The medium may be a physical storage medium such as a Read Only Memory (ROM) chip. Alternatively, it may be a disk such as a Digital Video Disk (DVD-ROM) or Compact Disk (CD-ROM). It could also be a signal such as an electronic signal over wires, an optical signal or a radio signal such as to a satellite or the like. The invention also extends to a processor running the software or code, e.g. a computer configured to carry out the method described above.

Preferred embodiments of the invention are described below, by way of example only, with reference to the accompanying drawings.

### BRIEF DESCRIPTION OF THE DRAWINGS

FIG. 1 is a schematic diagram of a transcoding system;

FIG. 2 is a flow chart illustrating a pre-crawling of a web site; and

FIG. 3 is a flow chart illustrating transcoding a web page.

### DETAILED DESCRIPTION OF THE PREFERRED EMBODIMENTS

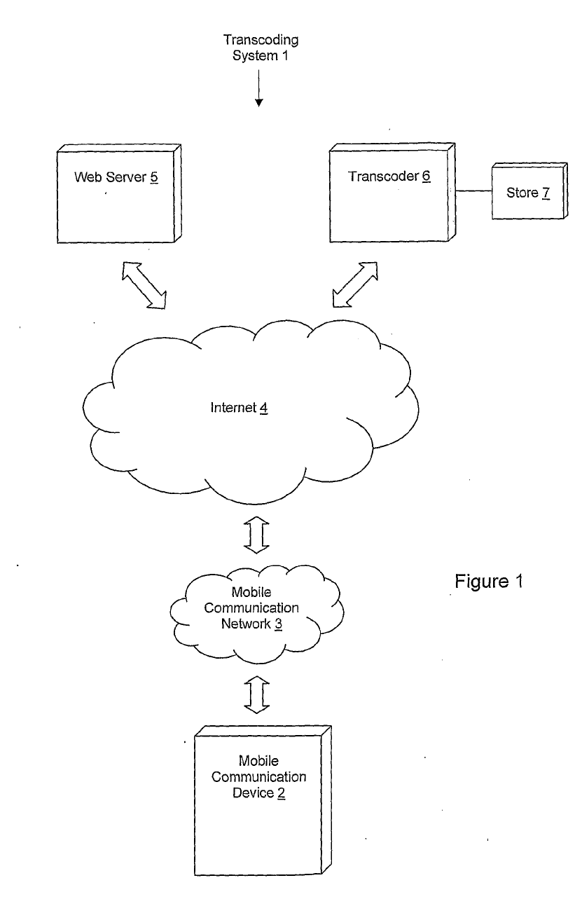

Referring to FIG. 1, a transcoding system 1 comprises a mobile communication device 2, such as a mobile telephone, Smartphone, Personal Digital Assistant (PDA) or such like, which can connect via a mobile communication network 3 to the internet 4. The mobile communication network 3 is typically a terrestrial or satellite mobile communication network. In other examples, the mobile communication device 2 uses a Wireless Local Area Network (WLAN) or such like to connect to the internet 4 instead of the mobile communication network 3. The mode of connection to the internet 4 is inessential, but the mobile communication device 2 itself is usually characterised by limitations in its ability to use web pages of web sites intended for use by desktop and laptop personal computers (PCs).

A web site intended for use by PCs is stored at a web server 5. However, the mobile communication device 2 does not access the web site at the web server 5 directly via the internet 4. Rather, when the mobile communication device 2 requests a web page of the web site stored at the web server 5, the request is routed to a transcoder 6. The transcoder 6 retrieves the web page from the web server 5. It then transcodes the web page and provides the transcoded web page to the mobile communication device 2 via the internet 4 and mobile communication network 3.

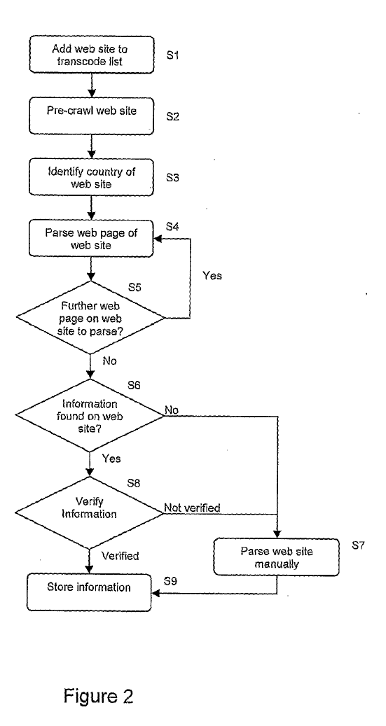

In more detail, referring to FIG. 2, when a transcoding service is activated for the web site stored at the web server 5, at step S1 the transcoder 6 adds the web site to a transcode list. In one example, this may include mapping one internet domain name that translates to the internet protocol (IP) address of the transcoder 6 to another internet domain name that translates to the IP address of the web server 5. In this way, requests including the first internet domain name are directed to the transcoder 6 via the internet 4 and the transcoder 6 knows from the mapping to retrieve the requested web page from the web server 5 for transcoding.

When a web site is added to the transcode list, at step S2 the transcoder 6 pre-crawls the web site. This involves retrieving web pages of the web site from the web server 5. The transcoder 6 traverses web pages of the web site and, at step S3 identifies a country to which the web site relates. The country may be identified from the country code top level domain (ccTLD) of the internet domain name. Alternatively, content of the web pages traversed may be analysed to identify country information, e.g. by identifying the language of the text on the web site.

At step S4, the transcoder 6 parses a web page of the web site using rules dependent on the identified country in order to extract information from the web page.

For example, the transcoder 6 can look for street address information. A rule used to identify street address information may comprise comparing text on the web page to a zip code template, which typically has the form XXXXX or XXXXX-XXX for the United States. Similarly a rule used to identify telephone number information may comprise comparing numbers on the web page to a telephone number template, such as +NNN N NNN NNNN for an international telephone number, or to area codes specific to the identified country. Telephone numbers can be distinguished from facsimile numbers by looking for text, such as “tel” and “fax” close to the numbers. If several addresses or telephone numbers are found, the first or most repeated address or number can be selected as the identified address or number. All identified information is extracted.

At step S5, the transcoder 6 checks whether any further web pages on the web site are available for parsing. If yes, another web page of the web site is parsed at step S4. If no, the transcoder 6 checks whether any information has been extracted from the web site. If no information has been extracted, the web site is added to a list of web sites to be forwarded for manual parsing at step S7. For example, the transcoder 6 may not be able to extract any information from a web site when telephone numbers and street addresses are rendered in images rather than text. However, manual parsing of the web site can readily identify such information. A service such as the “mechanical turk” service provided by Amazon®, see http://mturk.com can be used to perform the manual parsing.

If the transcoder 6 successfully extracts information from the web site, the information is verified at step S8. This may comprise comparing the extracted information to particular formats. For example, application programming interfaces (APIs) provided by search engines such as Google® can be used to check the format of information extracted. If the information is not verified, the web site may be added to the list of web sites for manual parsing at step S7. If the information is verified, it can be stored in a store 7 associated with the transcoder 6 at step S9. Likewise, after manual parsing of the web site at step S7, manually extracted information can be stored in the store 7 at step S9.

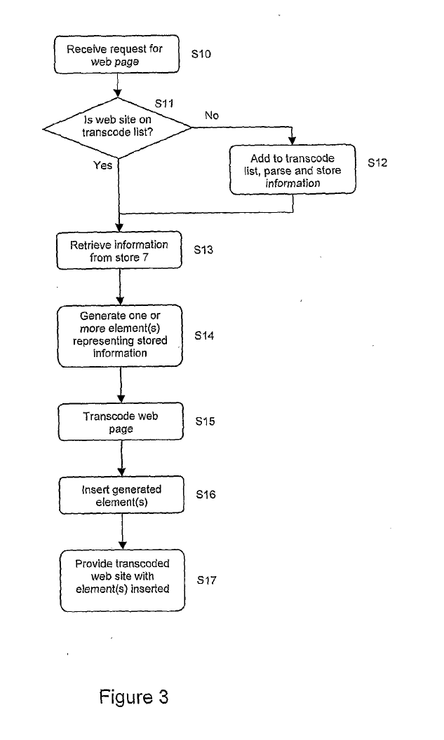

Referring to FIG. 3, when the transcoder 6 receives a request for a web page at step 810, the transcoder 6 checks whether the web site is on its transcode list at step S11. If the web site is not on the transcode list, it can be added to the transcode list and the pre-crawling process described in relation to FIG. 2 can be carried out in relation to the web site at step S12.

If the web site is on the transcode list or the pre-crawling is completed at step S12, the information stored for the web site can be retrieved from the store 7 at step S13. The transcoder 6 then generates one or more elements representing the stored information at step S14. For example, if street address information is stored for the web site, the transcoder 6 generates the text of the street address in a standard format and geographical data representing the location of the street address in a machine-readable format, such as that defined by the hCard open standard, which can be found at http://microformats.orq/wiki/hcard. In this example, the transcoder 6 also generates a map, e.g. using Google® Maps with an icon located at the street address. In another example, the transcoder 6 generates a link to such a map. The map is usually centered on the location. In other words, the icon is usually substantially at the centre of the map.

Similarly, if a telephone number is stored for the web site, the transcoder 6 generates a link relating to the telephone number. The link is encoded to initiate dialing of the telephone number on the mobile telecommunication device 2 upon selection by a user. In other words, the generated link comprises a click-to-call link.

If a brand logo is stored for the web site, the transcoder 6 generates an image of the logo having an appropriate size.

At step S15, the transcoder 6 retrieves the web page from the web server 5 and transcodes it. In this example, the transcoding is performed differently according to the type of mobile communication device 2 that requested the web page. The type of mobile communication device can be identified from the user agent string of the request for the web page. Knowledge of the capabilities of the type of mobile communication device 2 are used to control the transcoding process such that the transcoded version of the web page is appropriate for the capabilities of the type of mobile communication device 2.

At step S16, the elements generated by the transcoder 6 above are inserted in the transcoded web page. In this example, the brand logo, street address, telephone number and map are inserted at the top of the transcoded web page. In other examples, different elements can be inserted and the location of the elements can be selected as desired.

At step S17, the transcoded web site with the elements inserted is provided to the mobile telecommunication device 2 via the internet 4 and mobile communication network 3.

The described embodiments of the invention are only examples of how the invention may be implemented. Modifications, variations and changes to the described embodiments will occur to those having appropriate skills and knowledge. For example, as well as the pre-crawling process, the transcoder 6 may try to extract new information whenever a web page of a web site on the transcode list is transcoded. The information stored in the store 7 for the web site may therefore be continuously added to and improved. This keeps the transcoding up to date as new pages are added to the web site or the content of the web site is changed. These modifications, variations and changes may be made without departure from the scope of the invention defined in the claims and its equivalents.

1. A method of providing a transcoded web page of a web site, the method comprising:
parsing a plurality of web pages of the web site to extract information found on the web site;
storing the extracted information;
receiving a request for the web page;
transcoding the web page; and
providing the transcoded web page in response to the request, wherein transcoding the web page includes generating an element representing the stored information and inserting the element into the transcoded web page.

2. The method of claim 1, wherein the information is a street address found on the web site.

3. The method of claim 1, wherein the information is a map including an icon representing the location of a street address found on the web site.

4. The method of claim 1, wherein the element is a telephone number found on the web site.

5. The method of claim 4, wherein the element is a link related to a telephone number found on the web site, the selection of which link initiates dialing of the telephone number.

6. The method of claim 1, wherein the element represents a brand logo found on the web site.

7. The method of claim 1, wherein transcoding the web page includes inserting the generated element at the top of the transcoded web page.

8. The method of claim 1, wherein generating the element comprises converting street address information found on the web site to machine-readable geographic data and the element comprises the machine-readable geographic data.

9. The method of claim 1 further comprising:
parsing the plurality of web pages of the web site to generate extract information found on the web site; and
storing the further information;
wherein transcoding the web page includes generating a further element representing the stored further information and inserting the further element into the transcoded web page.

10. The method of any claim 1 wherein providing the transcoded web page in response to the request comprises providing the transcoded web page to a mobile communication device.

11. The method of claim 1 further comprising identifying a country to which the information found on the web site most likely relates and extracting the information using one or more rules associated with the identified country.

12. The method of claim 1 further comprising verifying the information.

13. Apparatus for providing a transcoded page of a web site, the apparatus comprising a transcoder for:
parsing a plurality of web pages of the web site to extract information found on the web site;
storing the extracted information;
receiving a request for the web page;
transcoding the web page; and
providing the transcoded web page in response to the request, wherein transcoding the web page includes generating an element representing the stored information and inserting the element into the transcoded web page.

14. Computer software for carrying out the method of claim 1 when processed by computer processing means.

15-16. (canceled)
